(19) United States
(12) Patent Application Publication
(10) Pub. No.: US 2017/0331798 A1
(43) Pub. Date: Nov. 16, 2017

(54) ENCRYPTED-BYPASS WEBRTC-BASED VOICE AND/OR VIDEO COMMUNICATION METHOD

(71) Applicant: NETAS TELEKOMUNIKASYON ANONIM SIRKETI, Istanbul (TR)

(72) Inventors: Cengiz TOGAY, Istanbul (TR); Fatih ODACI, Istanbul (TR)

(21) Appl. No.: 15/541,554

(22) PCT Filed: May 29, 2015
(86) PCT No.: PCT/TR2015/000241

§ 371 Date: Jul. 5, 2017

(30) Foreign Application Priority Data
Jan. 6, 2015 (TR) 2015/00128

(51) Int. Cl. H04L 29/06; H04L 9/06

(52) U.S. Cl. CPC H04L 63/0457; H04L 65/608; H04L 65/1073; H04L 63/205; H04L 63/0853; H04L 63/061; H04L 9/0631; H04L 9/0625

(57) ABSTRACT

An encrypted-bypass webRTC-based voice and/or video communication method provides dynamic use of the encryption algorithms in WebRTC communication.

### TECHNICAL FIELD

The invention relates to an encrypted-bypass webRTC-based voice and/or video communication method which provides dynamic use of the encryption algorithms in WebRTC communication.

### STATE OF THE ART

Today, webRTC-based communication is becoming increasingly important. Currently, the communication security is ensured by means of AES-based encryption algorithm. Use of different algorithms is needed due to various reasons. Thus, not only AES is used but TripleDES, Blowfish, etc. algorithms can also be used. Currently, WebRTC library does not provide this facility. Moreover, during the use of the library in the military or in the solutions requiring privacy, there is a need for providing the use of original encryption algorithms.

In the prior art search, an application No. CN102111416 has been encountered. Said application relates to a method for transmitting real-time data encryption over VoIP (Voice Over Internet Protocol).

To conclude, due to the aforementioned drawbacks and the inadequacy of the existing solutions with respect to the subject, a development is required to be made in the related technical field.

### OBJECT OF THE INVENTION

Developed by being inspired of the current conditions, the present invention aims to eliminate the above mentioned drawbacks.

Thanks to the method according to the invention, a method for performing encrypted media communication even on the unsecured networks is presented. The method according to the invention comprises two solutions. The first one is that communication can be provided with the algorithm selected by intervention in WebRTC library from the application level. In the second and particularly defined method, however, encryption of the dynamic files (dll or so) comprising encryption algorithms integrated with webRTC library and the packets used in communication can be provided by random hopping and the decryption thereof can be made in the opposite side. Both solutions provides webRTC with a property which is not available in the WebRTC library.

The structural and characteristic features and all the advantages of the present invention will be more clearly understood thanks to the FIGURES below and the detailed description written with reference to those FIGURES, therefore, the evaluation needs to be done by taking said FIGURES and the detailed description into consideration.

### FIGURES TO FACILITATE UNDERSTANDING OF THE INVENTION

FIG. 1 is the scheme illustrating the interconnection of the components which take part in performing the method according to the invention.

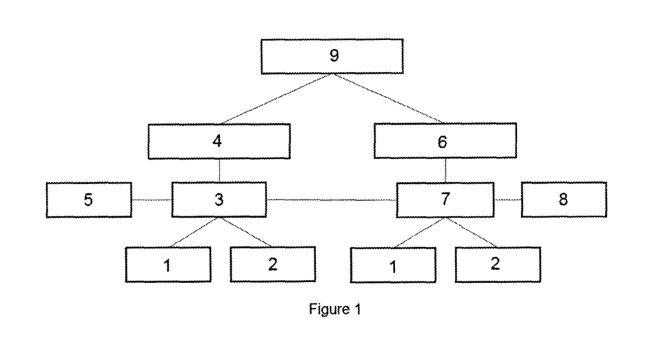

### DESCRIPTION OF THE PART REFERENCES

1. Encryption algorithm 1
2. Encryption algorithm 2
3. WebRTC library 1
4. Client application 1
5. Media source 1
6. Client application 2
7. WebRTC library 2
8. Media source 2
9. Server

### Meaning of the Abbreviations

### WebRTC: Web Real-Time Communication

### AES: Advanced Encryption Standard

### TripleDES: Triple Data Encryption Standard

### SDP: Session Description Protocol

### DTLS: Datagram Transport Layer Security

### UDP: User Datagram Protocol

The drawings do not need to be scaled and the details that are not necessary for understanding the present invention may have been ignored. Besides, the elements that are at least identical to a great extent or at least have identical functions to a great extent are referred with the same number.

### DETAILED DESCRIPTION OF THE INVENTION

In this detailed description, the preferred embodiments of the invention are described only for a better understanding of the subject.

The method according to the invention provides the client applications, namely the signaling activities between the internet browser applications in mobile or stationary devices having internet access which are employed by the users who desire to have a webRTC-based communication, to be performed with encrypted-bypass webRTC-based communication method. During performing said method, the components below, the features and functions of which are defined, are used:
Encryption algorithm 1 (1) performs the encryption process, wherein it is preferably AES algorithm.
Encryption algorithm 2 (2) performs the encryption process, wherein it is preferably TripleDES algorithm.
WebRTC library 1 (3) converts the content it receives from the media source 1 (5) into packets and encrypts and transfers the same to the opposite client, namely to the WebRTC library of the client application 2 (6), namely WebRTC library 2 (7) with UDP. Moreover, it decrypts the received packets and transfers the same to the screen and voice output unit.
WebRTC library 2 (7), has a similar function with WebRTC library 1 (3). WebRTC library 2 (7) converts the content it receives from the media source 2 (8) into packets and encrypts and transfers the same to the opposite client, namely to the WebRTC library of the client application 1 (4), namely WebRTC library 1 (3) with UDP. Moreover, it decrypts the received packets and transfers the same to the screen and voice output unit.
Client application 1 (4) and client application 2 (6) can be applications developed in a device having Android®, IOS®, Windows®, MacOS®, Linux® operating systems. Client application 1 (4) and client application 2 (6) identify themselves by registering in server application (9). Then, when a call is required to be initiated, transferring the keys to be used in call request and encryption with user name of the opposite client, namely client application 1 (4) and client application 2 (6) and receiving the respective responses is performed by means of the server application (9).
Media source 1 (5) and media source 2 (8) can be camera and/or microphone and/or microphone and/or screen and/or voice output source.
Server application (9) provides the signaling activities between the clients to be performed.

The process steps of the method according to the invention, which is realized by means of the components, the features of which are defined above, are as follows:
registering the client application 1 (4) and client application 2 (6) in the server application (9) by means of the client devices of the users (said client application 1 (4) and client application 2 (6) are registered in the server application (9) by the means such as user name, password or smart card and the user information can be accessible by the other users),
transferring the SDP packet received from WebRTC library 1 (3) to the client application 2 (6) by means of the server application (9) when voice and/or video communication is required to be provided from client application 1 (4) to the client application 2 (6),
transferring SDP packet received by the client application 2 (6) and the keys to be used in encryption for each encryption algorithm to the WebRTC library 2 (7),
transferring SDP packet with respect to the response received by the WebRTC library 2 (7) and the keys to be used in encryption for each encryption algorithm to the client application 1 (4) by means of the server application (9),
client application 1 (4) transferring the received SDP packet to the WebRTC library 1 (3),
WebRTC library 1 (3) encrypting the media content it receives from media source 1 (5), data packets which are present in the SDP packets and obtained over the agreed codecs by means of the defined encryption algorithm 1 (1) and encryption algorithm 2 (2) and transferring the same directly to the WebRTC library 2 (7),
with a modification made in WebRTC library 1 (3), the encryption algorithm 1 (1) or the encryption algorithm 2 (2) encrypting the packets randomly,
making a one-byte addition to the data section in the packet in order to show with which encryption algorithm the encryption is performed to the data packet formed, (for instance, if encryption algorithm 1 (1) is used 1 is written to the data section or if encryption algorithm 2 (2) is used 2 is written to the respective section)
transferring the packet obtained to the webRTC library 2 (7),
WebRTC library 2 (7) being informed about which encryption algorithm is used for encrypting the data packet from the added byte and decrypting the data packet with the respective encryption algorithm,
WebRTC library 2 (7) transferring the data packet it decrypts to the media source 2 (8).

In the preferred embodiments of the method according to the invention, the keys to be used for encryption can be changed by means of the WebRTC libraries from time to time. With the method used by the WebRTC libraries in the prior art, the keys of the encryption algorithms can be changed by means of DTSL or again server application (9) from time to time.

In a preferred embodiment of the method according to the invention, instead of AES which is currently used by WebRTC, different encryption algorithms can be changed during the call or the data packet can be pre-encrypted by means of a single encryption algorithm.

1. An encrypted-bypass webRTC-based voice and/or video communication method which provides dynamic use of the encryption algorithms in WebRTC communication, characterized in comprising the following process steps;
registering client application 1 and client application 2 in the server application by means of the client devices of users;
transferring the SDP packet received from WebRTC library 1 to the client application 2 by means of the server application when voice and/or video communication is required to be provided from client application 1 to the client application 2;
transferring SDP packet received by the client application 2 and the keys to be used in encryption for each encryption algorithm to the WebRTC library 2;
transferring SDP packet with respect to the response received by the WebRTC library 2 and the keys to be used in encryption for each encryption algorithm to the client application 1 by means of the server application;
client application 1 transferring the received SDP packet to the WebRTC library 1;
WebRTC library 1 encrypting the media content it receives from media source 1, data packets which are present in the SDP packets and obtained over the agreed codecs by means of the defined encryption algorithm 1 and encryption algorithm 2 and transferring the same directly to the WebRTC library 2;
with a modification made in WebRTC library 1, the encryption algorithm 1 or the encryption algorithm 2 encrypting the packets randomly;
making a one-byte addition to the data section in the packet in order to show with which encryption algorithm the encryption is performed to the data packet formed;
transferring the packet obtained to the webRTC library 2;
WebRTC library 2 being informed about which encryption algorithm is used for encrypting the data packet from the added byte and decrypting the data packet with the respective encryption algorithm;
WebRTC library 2 transferring the data packet it decrypts to the media source 2.

2. The method as in claim 1, characterized in that client application 1 and client application 2 are the same algorithms or different algorithm types.

3. The method as in claim 1, characterized in that media source 1 and media source 2 are camera and/or microphone and/or screen and/or voice output source.

4. The method as in claim 1, characterized in that the keys to be used for encryption can be changed by means of WebRTC libraries when desired.
